(19) United States
(12) Patent Application Publication
(10) Pub. No.: US 2023/0008814 A1
(43) Pub. Date: Jan. 12, 2023

(54) CONTINUOUS CURING RATE CHANGE TYPE GEL NAIL

(71) Applicant: LUPIN COMPANY INC., Seoul (KR)

(72) Inventors: Ho Keun Kim, Gyeonggi-do (KR); Hwan Hee Koo, Gyeonggi-do (KR)

(21) Appl. No.: 17/405,447

(22) Filed: Aug. 18, 2021

(30) Foreign Application Priority Data
Jul. 9, 2021 (KR) 10-2021-0090054

(51) Int. Cl. A45D 31/00

(52) U.S. Cl. CPC A45D 31/00; A45D 2200/205

(57) ABSTRACT

Provided is a continuous curing rate change type gel nail, and more particularly, a continuous curing rate change type gel nail characterized in that a curing rate of a resin portion of a gel nail is continuously changed from a soft property to a hard property.

### CROSS-REFERENCE TO RELATED APPLICATION

This application claims priority of Korean Patent Application No. 10-2021-0090054, filed on Jul. 9, 2021, in the KIPO (Korean Intellectual Property Office), the disclosure of which is incorporated herein entirely by reference.

### BACKGROUND OF THE INVENTION

### Field of the Invention

The disclosure relates to a continuous curing rate change type gel nail, and more particularly, to a continuous curing rate change type gel nail characterized in that a curing rate of a resin portion of a gel nail is continuously changed from a soft property to a hard property.

### Description of the Related Art

Nail decoration has become a fast-growing part of fashion and is popular regardless of age. Nail decoration plays an important role in expressing oneself via self-satisfaction of self-realization, and is increasingly used to express one's own individuality and beauty according to diversification, individuation, and premiumization.

To this end, various nail materials and design techniques reflecting tastes of consumers who are always looking for new things are being studied. However, applying nail polish or the like can be inconvenient because the work not only is very troublesome and tricky, but also takes a long time.

To solver these issues, gel nails have been developed. Gel nails come as stickers that include hard materials or are naturally cured quickly when adhered, and thus have excellent durability and aesthetics.

In this regard, gel nail stickers disclosed in KR 10-1797203 have been provided. KR 10-1797203 relates to soft gel nail stickers that are cured via ultraviolet (UV) rays after being adhered and worn on nails.

Despite the excellent durability, gel nails, are difficult to apply in uniform and aesthetic shapes.

### SUMMARY OF THE INVENTION

Provided is a gel nail that has improved wearability and aesthetics compared to a nail sticker and gel nail sticker of the related art, while having a reduced time for nail art and easy curing.

Additional aspects will be set forth in part in the description which follows and, in part, will be apparent from the description, or may be learned by practice of the presented embodiments.

According to one or more embodiments, a gel nail has a curing rate continuously changing from a soft property to a hard property in a length direction.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a perspective view of a gel nail according to a first embodiment of the disclosure;

FIG. 2 is a perspective view of a gel nail according to a second embodiment of the disclosure;

FIG. 3 is a perspective view of a gel nail according to a third embodiment of the disclosure;

FIG. 4 is a perspective view of a gel nail according to a fourth embodiment of the disclosure;

FIG. 5 is a cross-sectional view of a gel nail according to an embodiment of the disclosure;

FIG. 6 is a cross-sectional view of the gel nail according to the first embodiment of the disclosure;

FIG. 7 is a cross-sectional view of the gel nail according to the second embodiment of the disclosure;

FIG. 8 is a cross-sectional view of the gel nail according to the third embodiment of the disclosure;

FIG. 9 is a cross-sectional view of the gel nail according to the fourth embodiment of the disclosure; and

FIG. 10 is a diagram of a use state of a gel nail according to an embodiment of the disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

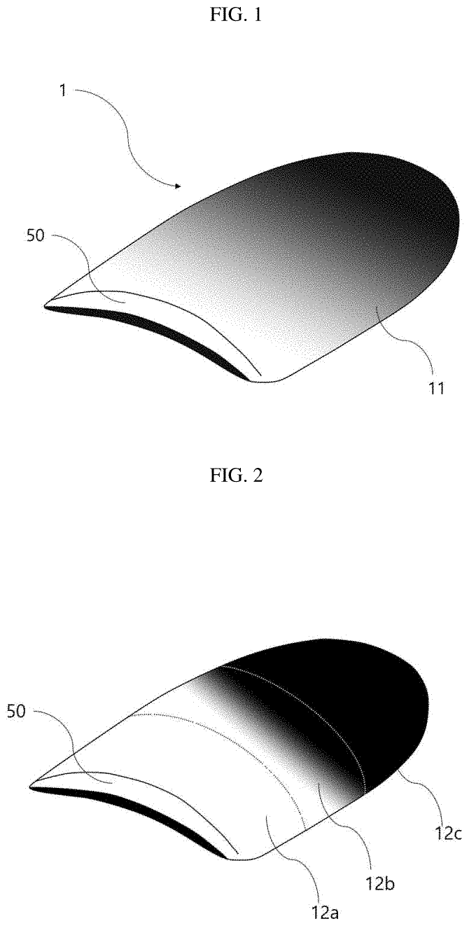

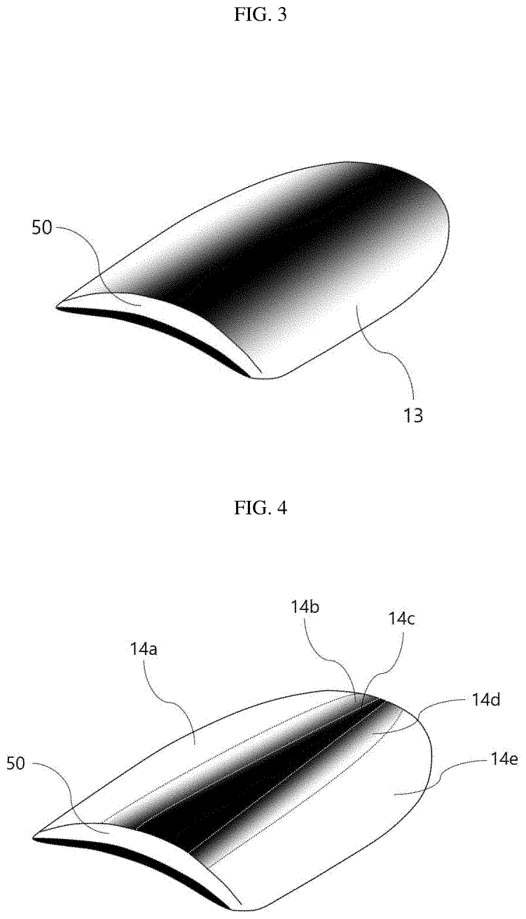

FIG. 1 is a perspective view of a gel nail according to a first embodiment of the disclosure, FIG. 2 is a perspective view of a gel nail according to a second embodiment of the disclosure, FIG. 3 is a perspective view of a gel nail according to a third embodiment of the disclosure, and FIG. 4 is a perspective view of a gel nail according to a fourth embodiment of the disclosure.

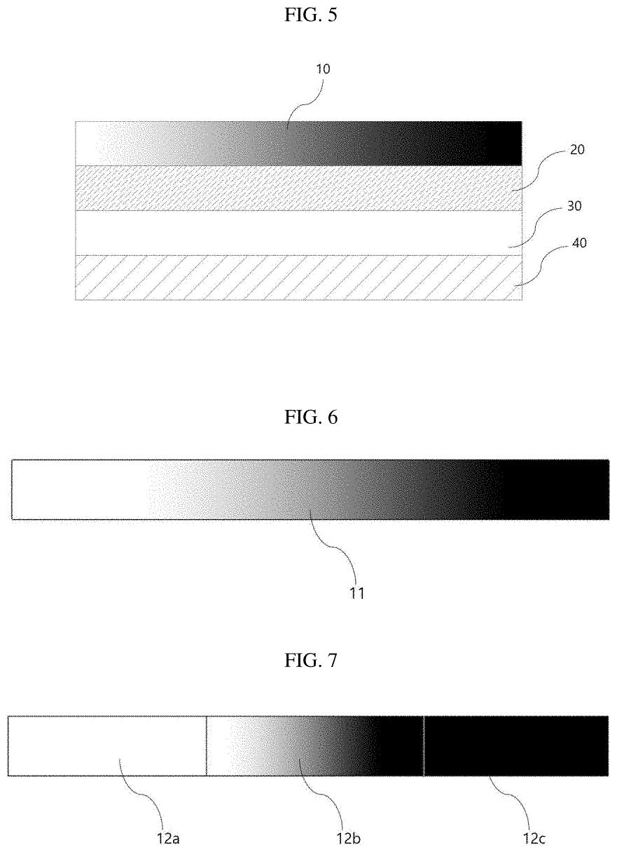

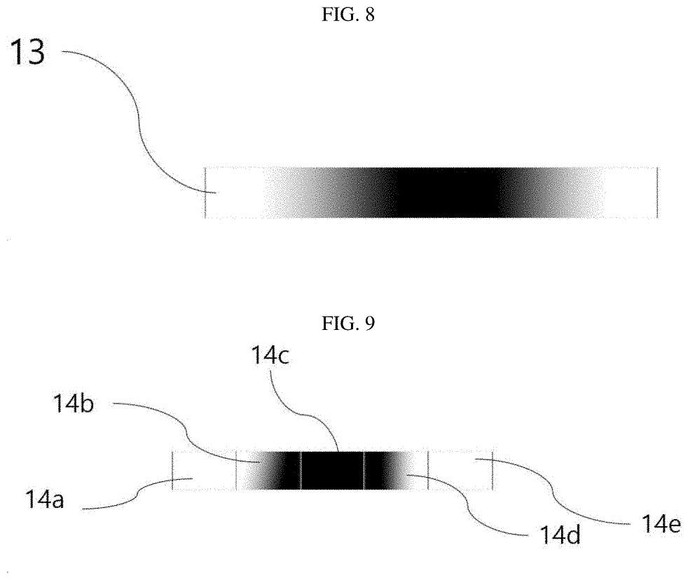

FIG. 5 is a cross-sectional view of a gel nail according to an embodiment of the disclosure, FIG. 6 is a cross-sectional view of the gel nail according to the first embodiment of the disclosure, FIG. 7 is a cross-sectional view of the gel nail according to the second embodiment of the disclosure, FIG. 8 is a cross-sectional view of the gel nail according to the third embodiment of the disclosure, and FIG. 9 is a cross-sectional view of the gel nail according to the fourth embodiment of the disclosure.

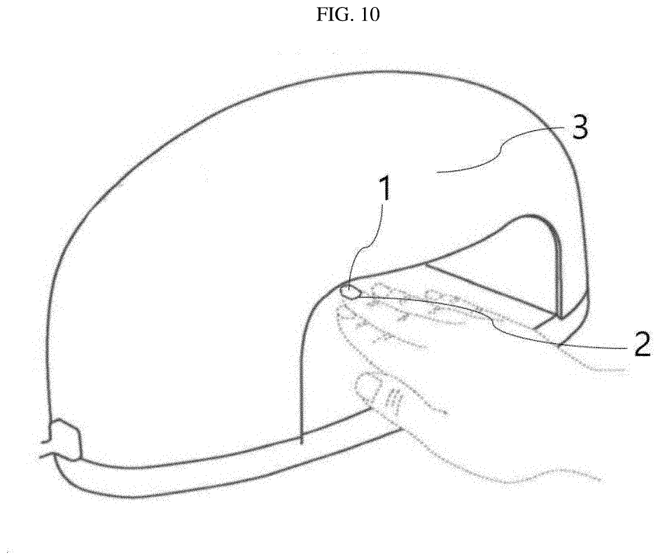

FIG. 10 is a diagram of a use state of a gel nail according to an embodiment of the disclosure.

A gel nail 1 according to an embodiment of the disclosure may be used by being attached to a nail 2 of a user and then cured via an ultraviolet (UV) lamp 3 when a UV ray curable material is applied.

An embodiment of the disclosure relates to a gel nail used by being attached and cured to decorate and extend a nail or a toenail.

As shown in FIG. 5, the gel nail 1 according to an embodiment of the disclosure may include a gel layer 10, a design layer 20, an adhesive layer 30, and a release paper 40, or may include only the gel layer 10 having adhesive in a soft state.

The adhesive layer 30 is a portion attached to a nail or toenail and has an adhesive property.

The release paper 40 is a portion located below the adhesive layer 30, protecting the adhesive layer 30, and released when the gel nail 1 is used. The release paper 40 is a paper or synthetic resin material that is commonly used for a sticker and detached when the sticker is put on, and according to an embodiment, the release paper 40 is separated and removed for the gel nail 1 to be used.

The design layer 20 is a portion located above the adhesive layer 30 and representing a color and/or a design. According to an embodiment, the design is represented on a synthetic resin material via a printing method, but the design layer 20 may be formed by using a synthetic resin material having a color or by coating or coloring a synthetic resin material with ink.

The gel layer 10 is a portion formed of a curable material, and is a portion located above the design layer 20, formed of the curable material to have a unique gloss effect, protecting the design layer 20, and making the nail of a user visually shiny.

The gel layer 10 is formed of hybrid resin including a continuous changing portion that continuously changes from a soft property to a hard property in a length direction.

Embodiments of the disclosure provide four types of gel layers.

In FIGS. 1 through 4, a soft portion is shown in white and a hard portion is shown in black.

In the first embodiment, a curing degree of an entire area continuously changes as shown in FIG. 1. Accordingly, an entire area of a hybrid resin 11 corresponds to a continuous changing portion.

A rear end portion of the gel layer 10, which is adjacent to cuticle of a nail, is soft and an outer front end portion thereof is hard.

The second embodiment is similar to the first embodiment, except that a curing degree continuously changes in a partial area as shown in FIG. 2. In the second embodiment, the gel layer 10 is formed of a hybrid resin including a soft portion 12a, a continuous changing portion 12b, and a hard portion 12c.

In the third embodiment, a curing degree of a hybrid resin 13 of an entire area continuously changes as shown in FIG. 3. A difference from the first embodiment is that, in the first embodiment, the curing degree increases from a rear portion to a front portion, whereas in the third embodiment, the curing degree increases from a center line to both side surfaces.

The fourth embodiment is similar to the third embodiment, except that a curing degree continuously changes only in a partial area as shown in FIG. 4. In the fourth embodiment, the gel layer 10 is formed of a hybrid resin including soft portions 14a and 14e, continuous changing portions 14b and 14d, and a hard portion 14c.

In the first and second embodiments, a soft portion is attached to a nail and a hard portion is a portion extending from the nail.

In the third and fourth embodiments, a hard portion functions as a center axis of a gel nail and supports a portion attached to a nail and an extending portion to be naturally connected, and a soft portion is adhered according to a curvature of the nail of each user.

Here, according to an embodiment of the disclosure, the hard portion may be in a fully cured state or may be in a 60 to 70% cured state to be elastic while a shape is fixed. Also, the soft portion may be in a half-cured state such that a shape is changeable.

An embodiment of the disclosure is attached to a nail according to various shapes of the nail as shown in FIG. 10, and a front surface thereof is supported by a hard portion to exhibit an extension effect.

According to a gel nail of an embodiment of the disclosure, a soft portion conforms to a curvature of a nail, a hard portion has a nail extending portion maintaining an elegant curve shape, and a soft property and a hard property are continuously changed, and thus the gel nail may have a smooth surface without a boundary even after being cured with an ultraviolet (UV) lamp.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A continuous curing rate change type gel nail used by being attached and cured to decorate and extend a nail or toenail, the continuous curing rate change type gel nail comprising:
a gel layer formed of a curable material, wherein the gel layer is formed of hybrid resin including; and
a continuous changing portion that continuously changes from a soft property to a hard property in a length direction.

2. The continuous curing rate change type gel nail of claim 1, wherein a rear end portion of the gel layer adjacent to a cuticle of the nail is soft and an outer front end portion of the gel layer is hard.

3. The continuous curing rate change type gel nail of claim 2, wherein the hard portion is in a 60-70% cured state.

4. The continuous curing rate change type gel nail of claim 2, wherein the gel layer further comprises:
a soft portion adjacent to the cuticle; and
a hard portion,
wherein the continuous changing portion is located between the soft portion and the hard portion.

5. The continuous curing rate change type gel nail of claim 4, wherein the hard portion is in a 60-70% cured state.

6. The continuous curing rate change type gel nail of claim 1, wherein a portion of the gel layer is hard, and a side end portion of the gel layer is soft.

7. The continuous curing rate change type gel nail of claim 6, wherein the hard portion is in a 60-70% cured state.

8. The continuous curing rate change type gel nail of claim 6, wherein the gel layer further comprises:
a soft portion on the side end; and
a hard portion,
wherein the continuous changing portion is located between the soft portion and the hard portion.

9. The continuous curing rate change type gel nail of claim 8, wherein the hard portion is in a 60-70% cured state.

10. The continuous curing rate change type gel nail of claim 1, wherein a center portion of the gel layer is hard and both side end portions of the gel layer are soft.

11. The continuous curing rate change type gel nail of claim 10, wherein the hard portion is in a 60-70% cured state.

12. The continuous curing rate change type gel nail of claim 10, wherein the gel layer further comprises:
a soft portion on each side end; and
a hard portion in the center,
wherein the continuous changing portion is located between each soft portion and the hard portion.

13. The continuous curing rate change type gel nail of claim 12, wherein the hard portion is in a 60-70% cured state.
